(19) United States
(12) Patent Application Publication
(10) Pub. No.: US 2003/0223436 A1
(43) Pub. Date: Dec. 4, 2003

(54) System for managing networks

(76) Inventors: Peter Lohrmann, Eislingen (DE); Volker Seefried, Esslingen (DE)

Correspondence Address: CROWELL & MORING LLP, INTELLECTUAL PROPERTY GROUP, P.O. BOX 14300, WASHINGTON, DC, 20044-4300, US

(21) Appl. No.: 10/384,777

(22) Filed: Mar. 11, 2003

(30) Foreign Application Priority Data
Mar. 12, 2002 (DE) 102 10 664.9

(51) Int. Cl. H04L 12/28

(52) U.S. Cl. 370/401; 370/410

(57) ABSTRACT

In a system for managing networks in a transportation unit, subscribers to the network are equipped with a network management functionality, by which they can be switched into and out of an operating mode with lower power drain. A network manager transmits a switch-off signal over the network in order to switch one or more subscribers into a state that is without network communication capability, and each subscriber is capable of being awakened again by a message over the network. The network is formed from a plurality of network segments that are separated from one another by means of at least one gateway. The network manager for all the subscribers of a network segment switches the network segment off if no subscriber thereto is any longer required by another network segment, and each subscriber is able to be switched off.

### BACKGROUND AND SUMMARY OF THE INVENTION

This application claims the priority of German patent document 102 10 664.9, filed Mar. 12, 2002, the disclosure of which is expressly incorporated by reference herein.

The invention relates to a system for managing communications networks in motor vehicles.

In motor vehicles, control units communicate over different networks, what are referred to as data bus systems, data bus segments or network segments. The latter are operated independently of one another, but as part of the overall network of the vehicle they have to exchange messages with one another. The interface between the network segments is generally implemented in a control unit (which also contains application functions) referred to as a “gateway”. For example, a data bus in the engine compartment is connected to a data bus in the interior via a gateway. In this way, a control unit which is connected via a data bus in the engine compartment can communicate with a control unit in the interior.

The functions of a gateway include, inter alia, the provision of services for controlling the system-wide operation of the network. For example, a gateway is responsible for “routing” messages from and to various network segments.

The OSEK standard (for open systems and their interfaces for electronics in motor vehicles) and ISO 15765 have disclosed a control-unit operating system, a network management system and a communications protocol for control units in network systems. The OSEK standard for open architecture is composed of three elements: i) communication for defining the exchange of data in and between control units, ii) a network management system for determining and monitoring configurations, and iii) a definition of the operating system for ECUs (Engine Control Units). Here, the network management system of the OSEK standard makes available the following functionalities for managing networks: initialization of ECU resources, for example network interface, starting of the network, configuration of the network, node monitoring, detection, processing, signaling of states of nodes or network, setting of network and node specific parameters, coordination of global operating modes of the network, diagnostic support etc.

As in the previously mentioned example of the engine compartment or interior data bus, the different network segments must then be combined to form a communicating network of the vehicle by means of a network management system, for example of the OSEK standard. However, it is to be ensured here that the different network segments may make different demands of the communication processes with the network or its subscribers.

One object of the invention is to provide a system for efficiently controlling such a network which comprises a plurality of network segments.

This and other objects and advantages are achieved by the network according to the invention, which is formed from a plurality of network segments that are separated from one another by at least one gateway. The network manager for all the subscribers of a network segment senses whether they can be switched off (into a state that is without network communication), and whether another network segment requires a subscriber of the network segment that is to be switched off. The network manager switches the network segment off if no subscriber is any longer required by another network segment, and each subscriber is characterized as able to be switched off.

The system according to the invention has the advantage that it is independent of the number of network segments and does not require any explicit master (monitor) either. Instead, the system monitors itself. In addition, network segments can be dynamically added to and removed from the system.

The system is preferably suitable for operating network segments which are based on different bus systems, since the actual data bus system in the network segment is not significant for managing network segments.

It is advantageous to manage the network segments at the gateway in classes, for example synchronously and selectively. Synchronous operation means that certain network segments which are characterized as synchronous are jointly switched on or off at the gateway by the network manager of the gateway. This has the further advantage that in the standard operating mode the network can ultimately also be switched on or off.

A network segment which is managed selectively can be switched on or off independently of the synchronously managed network segments at the gateway. It is also the case that due to a communication error of a subscriber during the synchronous operating mode it is possible to temporarily operate an individual network segment in this selective state.

The system is advantageous in particular for dynamic monitoring of network segments as it permits the dynamic exclusion of faulty network segments and the re-integration of only temporarily disrupted network segments into the synchronous operating mode.

There are then various possible ways of advantageously configuring and developing the teaching of the present invention.

Other objects, advantages and novel features of the present invention will become apparent from the following detailed description of the invention when considered in conjunction with the accompanying drawings.

### BRIEF DESCRIPTION OF THE DRAWINGS

FIG. 1 shows a network composed of network segments and subscribes; and

FIG. 2 shows a state diagram of the network manager.

### DETAILED DESCRIPTION OF THE DRAWINGS

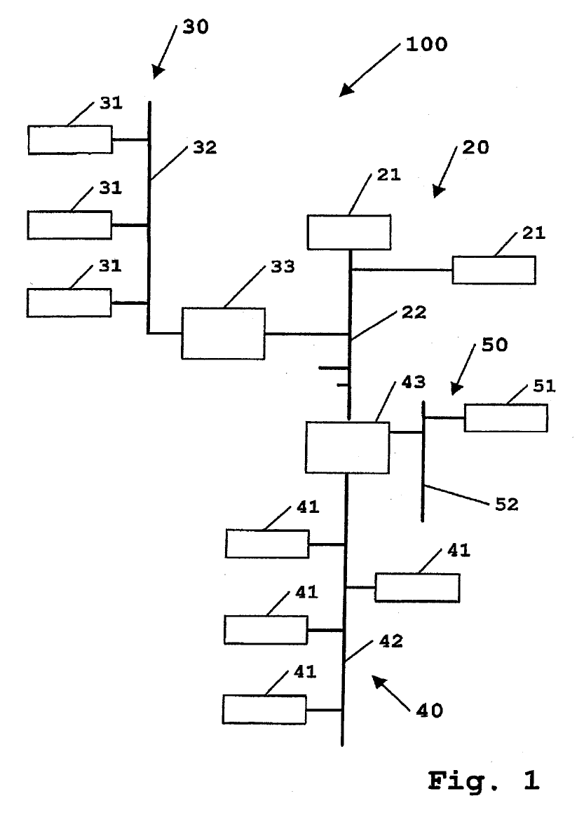

FIG. 1 shows a network 100 for the communication of control units or control unit applications in a means of transportation, particularly a vehicle. The subscribers 21, 31, 41, 51, 33, 43 of such a network 100 exchange data via the network 100.

The network 100 is composed of a plurality of network segments 20, 30, 40, 50, which are physically connected via gateways 33, 43. A gateway 33, 43 is thus a subscriber which connects at least two network segments 20, 30, 40, 50 to one another. The subscribers 21, 31, 41, 51, 33, 43 are physically connected to one another within one of network segments 20, 30, 40, 50, by respective data buses 22, 42, 52 and 32, which are DC-isolated via the gateway 43 or 33. The network segments 20, 30, 40, 50 are part of the network 100 which can exchange messages independently; that is, it is embodied as a logic ring or logic star.

In the exemplary embodiment, the data buses 22, 32, 42, 52 are CAN buses, but the system can be implemented with any other data bus system or combinations of data bus systems. Examples of further data bus systems which can be used within a network segment 20, 30, 40, 50 are D2B, MOST, FlexRay, LIN etc. The various data bus systems are selected according to their location of use in the vehicle. The control of the engine can be processed for example via a CAN data bus system, while it is appropriate to use a MOST data bus system for audio and telephone systems. The data bus systems 22, 32, 42, 52 are, as mentioned above, DC-isolated by the gateway or gateways 33, 43.

The subscribers 21, 31, 41, 51, 33, 43 are control units or control unit applications such as actuators or sensors. The gateways 33, 43 have not only control unit applications but also an extended network functionality for passing on messages from one network segment to a further network segment 20, 30, 40, 50.

In order to exchange, data and to monitor the network between the subscribers 21, 31, 33, 41, 43, 51, standards are used which are already established in the field of software and hardware for vehicles. The exemplary embodiment uses the OSEK standard, mentioned above.

In the exemplary embodiment, the operating system of each subscriber 21, 31, 33, 41, 43, 51 has stand-alone network monitoring functionalities for each network segment 20, 30, 40, 50. The network management system stores information on the state of the network 100 or of the network segments 20, 30, 40, 50 of the network 100 and of the subscribers 21, 31, 33, 41, 43, 51. The states comprise at least

a network-management-system emergency operating mode state if a gateway 33, 43 does not receive any response from the data bus 22, 32, 42, 52;

a BusSleep state if a data bus 22, 32, 42, 52 of a network segment 20, 30, 40, 50 is switched off;

a WaitBusSleep state if subscribers 21, 31, 33, 41, 43, 51 of a network segment 20, 30, 40, 50 do not feed any message on to the data bus 22, 32, 42, 52;

a NetSleep state if a network 100 can be switched off; and

a WakeNetSleep state if a network segment waits for the NetSleep state.

The gateways 33, 43 perform the additional function of the expanded network segment management system by means of a service which is implemented therein by means of software. This service is hereinafter referred to as network manager, NM for short, and is used for synchronously powering down or waking up the individual network segments 20, 30, 40, 50 which are connected to the gateway 33, 43. Synchronously in this context means that certain network segments 20, 30, 40, 50 which are characterized as synchronous are switched on or off jointly by the network manager of the corresponding gateway 33, 43 so that ultimately the corresponding gateway 33, 43 can also be switched on or off in the standard operating mode. In addition, the network manager has interfaces for communicating with the control unit applications of the subscribers 21, 31, 33, 41, 43, 51 in the individual network segments 20, 30, 40, 50.

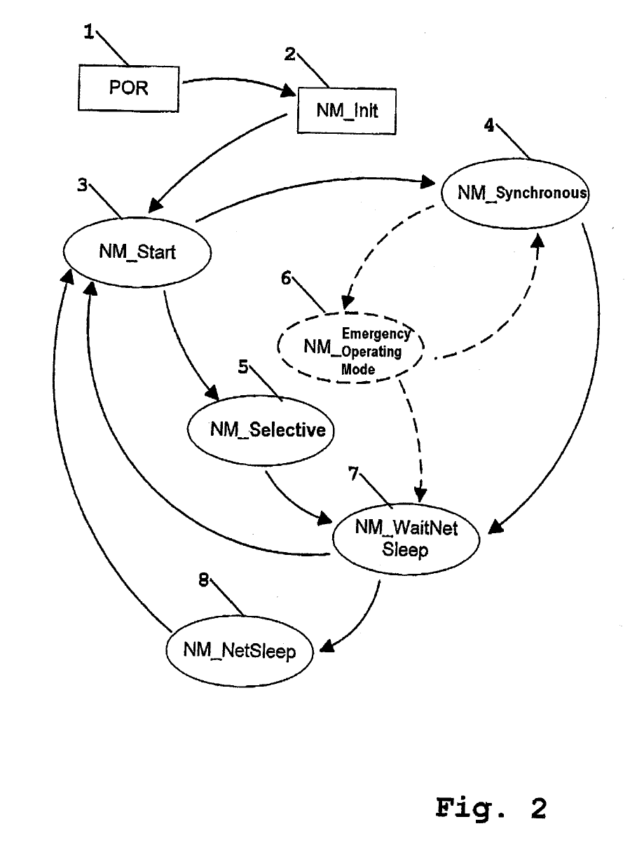

In FIG. 2, a state diagram of the network manager is mapped onto the network 100 described above.

In the state 1, POR—Power On Reset—either the entire network 100, only the gateway 33, 43 or the individual network segments 20, 30, 40, 50 are powered up. This corresponds to switching on the voltage supply for the network subscribers 21, 31, 33, 41, 43, 51 which is initiated generally by plugging in and turning the ignition key in the vehicle.

In state 2, NM_Init, the network manager is initialized according to a predefined configuration. In addition, the network management functionality of the network segments 20, 30, 40, 50 which are connected to the gateway 33, 43 is initialized if this has not already taken place.

In state 3, NM_Start, the network manager determines, on the basis of the configuration stored in the gateway 33, 43, whether the respective network segment 20, 30, 40, 50 which is connected to the gateway is to be operated or administered synchronously or selectively. The network manager starts, for each network segment 20, 30, 40, 50, an entity of the network manager which performs the monitoring of the respective network segment 20, 30, 40, 50. For this purpose, in order to manage network segments 20, 30, 40, 50 which are to be operated synchronously, the network manager changes into the state 4, NM_Synchron. The management of the network segments 20, 30, 40, 50 which are to be operated selectively is controlled by the network manager by means of the state 5, NM_Selective.

In the state 4, there is cyclical checking to determine whether the network segment 20, 30, 40, 50 which is characterized as synchronous is running in a stable manner. If a particular network segment is not, in state 4 it is removed from the management of the network segments 20, 30, 40, 50 which are to be managed synchronously. This has the advantage that the remaining synchronous network segments 20, 30, 40, 50 can be switched on or off synchronously, that is to say jointly, by the corresponding gateway 33, 43.

If, in the state 4, a network segment 20, 30, 40, 50 which is managed synchronously is switched off by the network manager, and the data bus 22, 32, 42, 52 has been switched into the state BusSleep, the network manager or the respective entities of this service for the synchronously managed network segment change into the state NM_WaitNetSleep 7.

In the state NM_WaitNetSleep 7 of the network manager it is monitored whether all the network segments 20, 30, 40, 50 are in the BusSleep state and whether wake-up requests are present. In addition, in the state NM_WaitNetSleep 7 the network manager prevents communication from network segments 20, 30, 40, 50 to the switched-off network segment 20, 30, 40, 50.

The network manager changes into the state NM_NetSleep 8 if all the network segments 20, 30, 40, 50 are in the BusSleep state. In this way, all the network segments 20, 30, 40, 50 at a gateway 33, 43 are switched off and the gateway 33, 43 can then be switched off if no contrary requests come from the network 100.

If any application within a network segment 20, 30, 40, 50 requires any network segment 20, 30, 40, 50 again and the network manager is in the state NM_WaitNetSleep 7, the network manager changes into the state NM_Start 3. At the changeover into the state NM_Start 3, the synchronously managed network segments 20, 30, 40, 50 are awakened synchronously (jointly) by means of the corresponding gateway 33, 43.

In the state NM_NetSleep 8, all the network segments 20, 30, 40, 50 are asleep (in the BusSleep state). In this state, the network 100 waits for a communication request by the user and then goes into the state NM_Start 3, or the network 100 is switched off completely.

The standardized network management system performs the checking for stability that is necessary in the state NM_Synchronous 4. This resets the RingStable bit of a network segment 20, 30, 40, 50 as soon as the logic ring of the network management is interrupted. If, after a waiting time, the network segment 20, 30, 40, 50 is no longer stable and is in neither the network management system emergency operating mode, the WaitBusSleep state not the BusSleep state, the network manager for the affected network segment 20, 30, 40, 50 changes to the state NM_Emergency Operating Mode 6. The registration of this network segment 20, 30, 40, 50 as a synchronously managed network segment 20, 30, 40, 50 is then cancelled by the network manager.

In the state NM_Emergency Operating Mode 6, there is continuous checking to determine whether a network segment 20, 30, 40, 50 which is not stable stabilizes again after a certain time period, or is in the network management system emergency operating mode. If the network segment 20, 30, 40, 50 can stabilize itself, or if it is in the network management system emergency operating mode, it goes back into the state NM_Synchronous 4. Here, it is registered again as a synchronously managed network segment 20, 30, 40, 50 in the network manager. If it cannot stabilize itself, it leaves this emergency operating state 6 and goes into the state NM_WaitNetSleep 7 if none of the control unit applications requires this network segment 20, 30, 40, 50 and all the synchronously managed network segments 20, 30, 40, 50 are in the BusSleep state. This is selected because it is possible that a subscriber 21, 31, 33, 41, 43, 51 of a synchronous network still requires information from the network segment 20, 30, 40, 50 which is in the state AD_Emergency OperatingMode 6.

If the network segment 20, 30, 40, 50 in the state NM_Emergency Operating Mode 6 receives an emergency wake-up call from a control unit application, the network manager wakes up all the other network segments 20, 30, 40, 50 which are to be managed synchronously. This functionality is necessary, because the fact that a particular network segment 20, 30, 40, 50 is not stable does not mean that all the control units therein have failed. Instead, the unstable network segment 20, 30, 40, 50, should also be given the possibility of waking up the entire network 100. In this way, a network segment 20, 30, 40, 50 (for example the interior bus) may be unstable due to the failure of an unimportant control unit (for example, an interior light switch); however, this failure should not prevent control units or control unit applications in the respective network segment from having access to the entire network 100. For this reason, a network segment 20, 30, 40, 50 in the state NM_Emergency Operating Mode 6 can also start an emergency wake-up call.

In the state NM_Selective 5, the network manager checks only whether a selectively managed network segment 20, 30, 40, 50 is in the BusSleep state. If the selectively managed network segment is in the BusSleep state, the network manager changes into the state NM_WaitNetSleep 7.

The interface for communication between the network manager and control unit applications is implemented in the exemplary embodiment as an API—Application Program(ming) Interface.

For powering down the network segments 20, 30, 40, 50, the interface contains functions for displaying the readiness to go into the sleep state and the wake-up request.

For initialization in the state NM_Init 2, the control unit application is provided with an interface (ADInitNm) with which the network manager initializes the connected network segments 20, 30, 40, 50. This function ADInitNm initializes all the connected network segments 20, 30, 40, 50 and the network management functions. The settings in the gateway 33, 43 for the respective network segments 20, 30, 40, 50 are defined before their use and called by the network manager.

The OSEK network management system makes available various information items which supply the current status of the network management system. In this way, it is possible for the network manager to access these internal states of the network management system and to react. These references are described below:

NmStateBus The network management system controls communication at the request of an application, which can cause a change into the sleep state or waking up.

Information bit: NmStateBusSleepInd/NmStateBusWakeUp

NmStateRingStable The network management system detects a stable ring communication in the network 100.

Information bit: NmStateRingStable

NmStateLimphome The network management system is in the emergency operating mode state.

Information bit: NmStateLimphome

NmPreNetSleepInd The network management system sets the NmPreNetSleepInd when each network management system message is sent. If a deleted SleepInd of another ring subscriber 21, 31, 33, 41, 43, 51 is received during the ring circulation, the NmPreNetSleepInd is also deleted.

Information bit: NmPreNetSleepInd

NmStateNetSleepInd The management has detected that all the control units 21, 31, 33, 41, 43, 51 at this network segment 20, 30, 40, 50 have signaled their readiness to go into the sleep state or into the switched-off state.

Information bit: NmStateNetSleepInd

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

What is claimed is:

1. A system for managing a network in a transportation device, wherein:
subscribers to the network are equipped with a network management functionality, by means of which said subscribers can be switched into and out of an operating mode with a reduced power drain;
at least one network manager is provided which transmits a switch-off signal over the network in order to switch a subscriber or subscribers into a state that is without network communication;
each subscriber can be awakened again by a message over the network;
the network is composed of a plurality of network segments that are separated from one another by at least one gateway;
a network manager for all subscribers to a first particular network segment senses whether said subscribers can be switched off, into a state that is without network communication, and whether a different network segment requires a subscriber of the network segment that is to be switched off; and
the network manager for all subscribers to the particular network segment switches off the network segment if no subscriber any longer is required by another network segment, and each subscriber is able to be switched off.

2. The system according to claim 1, wherein, if a network segment is switched off, communication between the other network segments is additionally interrupted by a gateway to the switched-off network segment.

3. The system according to claim 1, wherein selected network segments can be switched off and on by the network manager independently of power states and/or the requirements of other network segments.

4. The system according to claim 1, wherein when a network segment is operating in a state with network communication, the network manager checks whether all the subscribers of the network segment are capable of communication.

5. The system according to claim 4, wherein:
when a communication error occurs at a failed subscriber or a second particular network segment, the network manager changes the failed respective segment into an emergency operating mode; and
it is continuously checked whether the second particular subscriber or the failed network segment has in the meantime become capable of communicating again.

6. The system according to claim 5, wherein as soon as the second particular network segment and/or the failed subscriber no longer has a communication error, the second particular network segment is returned to the standard operating mode by the network manager.

7. The system according to claim 5, wherein the second particular network segment with a communication error, wakes up other subscribers or the other network segments in response to an emergency wake-up call by a subscriber.

8. The system according to claim 1, wherein a gateway can be switched off if all network segments connected to it are satisfactorily changed into the state without network communication.
